(19) United States
(12) Patent Application Publication
(10) Pub. No.: US 2017/0238594 A1
(43) Pub. Date: Aug. 24, 2017

(54) AUTOMATIC MACHINE FOR CLEANING UP AND CUTTING FRUIT, PARTICULARLY STRAWBERRIES OR RADISHES

(71) Applicant: Turatti S.r.l., Venice (IT)

(72) Inventor: Antonio TURATTI, Venice (IT)

(21) Appl. No.: 15/514,771

(22) PCT Filed: Sep. 28, 2015
(86) PCT No.: PCT/IT2015/000241

§ 371 Date: Mar. 27, 2017

(30) Foreign Application Priority Data
Sep. 26, 2014 (IT) RM2014A000553
Dec. 29, 2014 (IT) RM2014A000756

(51) Int. Cl. A23N 15/04; B26D 3/30; B26D 7/01; B26D 7/18; A23N 15/02; B26D 7/06

(52) U.S. Cl. CPC A23N 15/04; A23N 15/02; B26D 7/0625; B26D 7/018; B26D 7/18; B26D 3/30; B26D 7/0641; B26D 2210/02

(57) ABSTRACT

The present invention relates to an automatic machine for cutting fruit, particularly strawberries or radishes, comprising an aligning and transporting unit (4, 140, 340, 404) for aligning, according to at least one line, and transporting fruits (F) from an origin zone to a first destination zone; a placing and transporting unit (5, 5′, 150, 205, 350, 405) for placing said fruits (F) according to a predetermined orientation and transporting said fruits (F) from said first destination zone to a second destination zone, said placing and transporting unit (5, 5′, 150, 205, 350, 405) being arranged downstream said aligning and transporting unit (4, 140, 340, 404); a conveying unit (6, 160, 210, 406) for conveying said fruits (F) from said second destination zone to a third destination zone, said conveying unit (6, 160, 210, 406) comprising a vacuum-generating device (66) to make a respective waste portion of said fruits (F) adhering to said conveying unit (6, 160, 210) by vacuum, said conveying unit (6, 160, 210, 406) being arranged downstream said placing and transporting unit (5, 5′, 150, 205, 350, 405); and a cutting unit (7, 170, 211, 407) for cutting said fruits (F) in correspondence of said third destination zone such as to remove said respective waste portion of said fruits (F).

The present invention relates to an automatic machine for cutting fruit, particularly strawberries or radishes, but also different types of fruit.

In the following the specification will be addressed to working strawberries, but it is well evident that the same must not be considered limited to this specific use.

By cleaning of strawberries it is meant elimination of green leaves, also known as strawberry tuft.

As it is well known, machines are known for treating strawberries that are manually supplied by operators that must put strawberries on conveyor belts.

Particularly, operator takes a single strawberry from a suitable bin and put is properly on a conveyor belt bringing strawberries to the following working stations.

It is well evident that said machines require quite long working time, due to the time necessary for operator to take the single strawberry from a bin and putting the same on the machine conveyor belt.

It is therefore san object of the present invention that of providing an automatic machine for cleaning and cutting fruit, particularly strawberries and radishes, permitting overcoming problems and drawbacks of the known machines.

A further object of the invention is that of providing an automatic machine permitting obtaining a high production rate.

Another object of the invention is that of providing an automatic machine for cleaning and cutting fruit, particularly strawberries and radishes, that is reliable and that permit obtaining satisfying results in terms of final product.

Further object of the present invention is that of providing an automatic machine for cleaning and cutting fruit, particularly strawberries and radishes, permitting obtaining a high repetition of working results.

It is therefore specific object of the present invention an automatic machine for cutting fruit, particularly strawberries or radishes, comprising an aligning and transporting unit for aligning, according to at least one line, and transporting fruits from an origin zone to a first destination zone; a placing and transporting unit for placing said fruits according to a predetermined orientation and transporting said fruits from said first destination zone to a second destination zone, said placing and transporting unit being arranged downstream said aligning and transporting unit; a conveying unit for conveying said fruits from said second destination zone to a third destination zone, said conveying unit comprising a vacuum-generating device to make a respective waste portion of said fruits adhering to said conveying unit by vacuum, said conveying unit being arranged downstream said placing and transporting unit; and a cutting unit for cutting said fruits in correspondence of said third destination zone such as to remove said respective waste portion of said fruits.

Still according to the invention, said machine can comprise a feeding unit for supplying fruits to said aligning and transporting unit; said feeding unit being arranged upstream said aligning and transporting unit.

Preferably, according to the invention, said machine can comprise detection and orientation correction means to detect orientation of fruits and, when detected orientation is different from a predetermined orientation, to orient said fruits according to said predetermined orientation before said fruits arrive at said conveying unit.

Further according to the invention, said conveying unit can comprise a hollow cylinder having a lateral surface provided with a plurality of through holes configured to receive a portion of said fruits and in communication with said vacuum-generating device; said hollow cylinder being rotatable about its axis.

Advantageously, according to the invention, said conveying unit can comprise a case arranged inside said hollow cylinder so as to realize a chamber along with a portion of said hollow cylinder; said chamber being in communication with said vacuum-generating device and with through holes provided in said portion of said hollow cylinder.

Still according to the invention, said through holes of said plurality of through holes can be arranged according to at least one circumferential line.

Preferably, according to the invention, said placing and transporting unit can comprise at least a pair of ropes substantially parallel each other and arranged at such a distance each other to allow placing a fruit in a space comprised between said ropes, wherein each rope of said at least a pair of ropes is wound on a first pulley and on a second pulley; said placing and transporting unit further comprising moving means to make said at least one pair of ropes run on said first pulley and said second pulley.

Furthermore according to the invention, said placing and transporting unit can comprise a first conveyor belt, wherein at least one groove is formed, said at least one groove being configured so as to receive said fruits positioned with respective waste portion facing upwards, namely towards a direction opposite to said first conveyor belt.

Advantageously, according to the invention, said conveying unit can comprise a second conveyor belt provided with a plurality of holes which are in communication with said vacuum-generating device; said second conveyor belt being at least partially arranged above said first conveyor belt, so that fruits transported by said first conveyor belt are attracted from above towards said holes of said second conveyor belt by vacuum generated by said vacuum-generating device.

Still according to the invention, said third destination zone, where said fruits are cut, can be provided below said second conveyor belt.

Preferably, according to the invention, said machine can comprise a third conveyor belt for collecting respective waste portion of said fruits, and a fourth conveyor belt for collecting remaining portion of said fruits, said fourth conveyor belt being arranged below said third destination zone.

Furthermore, according to the invention, said aligning and transporting unit can comprise at least one channel having a lower portion which is tapered downward and open, and at least one movable member which is substantially comb-shaped and connected with a moving system adapted to make said movable member move in a substantially undulating way, such that, when in use, fruits arrive at the end of said at least one channel, which fruits being spaced apart by a predetermined reciprocal distance.

The present invention will be described for illustrative, but not limitative, purposes, according to its preferred embodiments, with particular reference to the figures of the enclosed drawings, wherein:

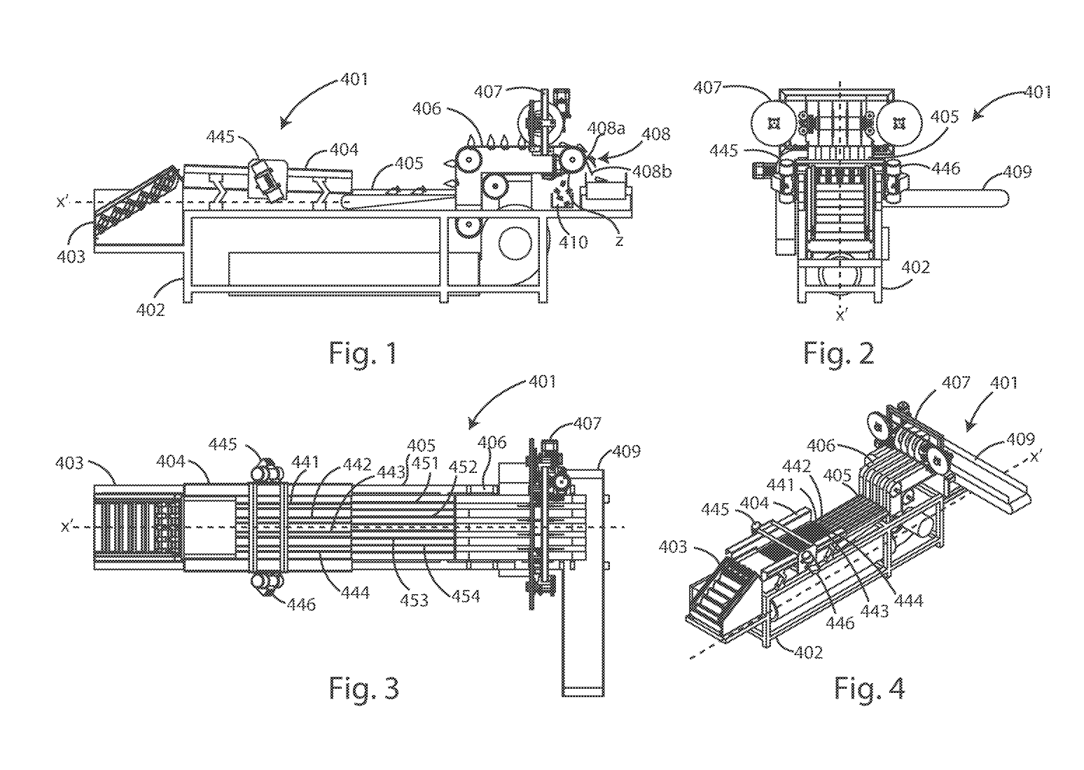

FIG. 1 shows a lateral view of an automatic machine for cleaning and cutting fruit, particularly strawberries and radishes, according to a first embodiment of the present invention;

FIG. 2 shows a front view of the machine of FIG. 1;

FIG. 3 shows a top view of the machine of FIGS. 1 and 2;

FIG. 4 shows a perspective view of the machine of FIGS. 1-3;

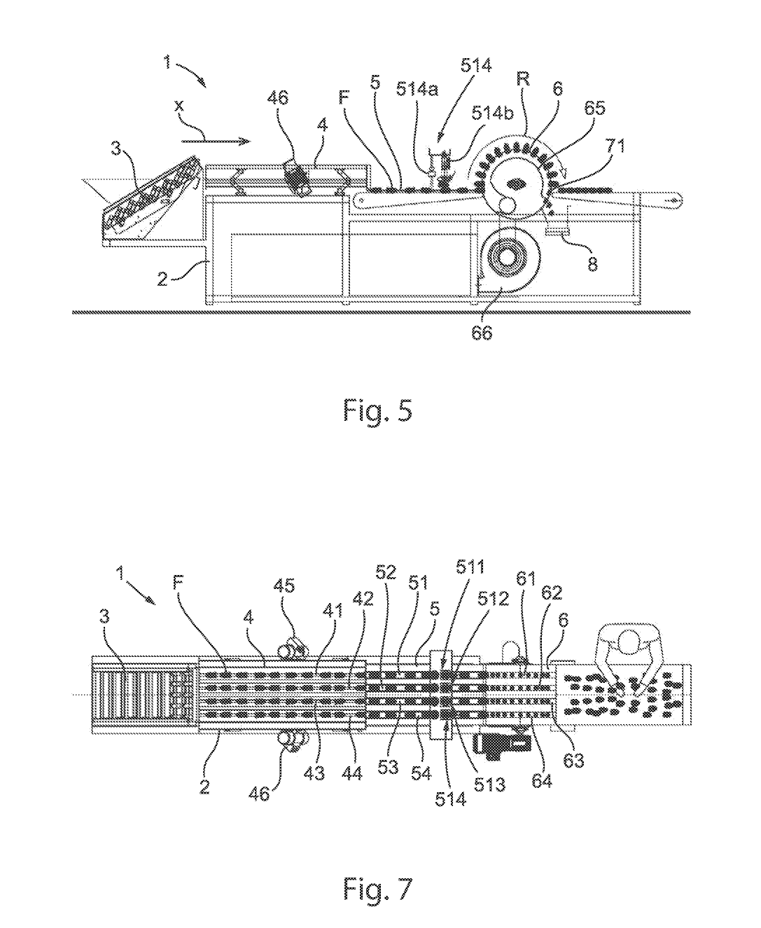

FIG. 5 shows a longitudinal section view of an automatic machine for cleaning and cutting fruit, particularly strawberries and radishes, according to a second embodiment of the present invention;

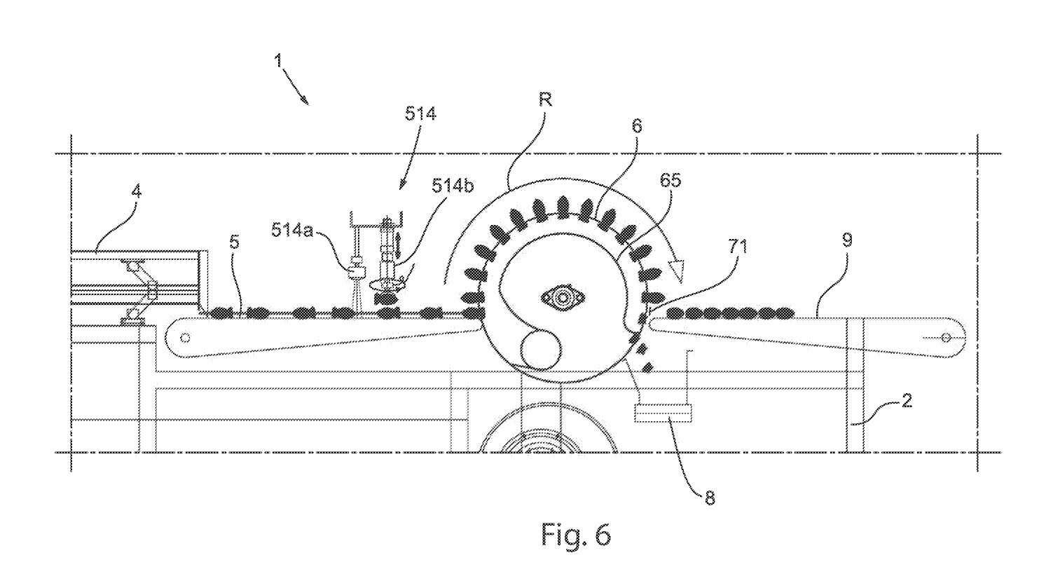

FIG. 6 is a detailed view of FIG. 5;

FIG. 7 shows a top plan view of the machine of FIG. 5;

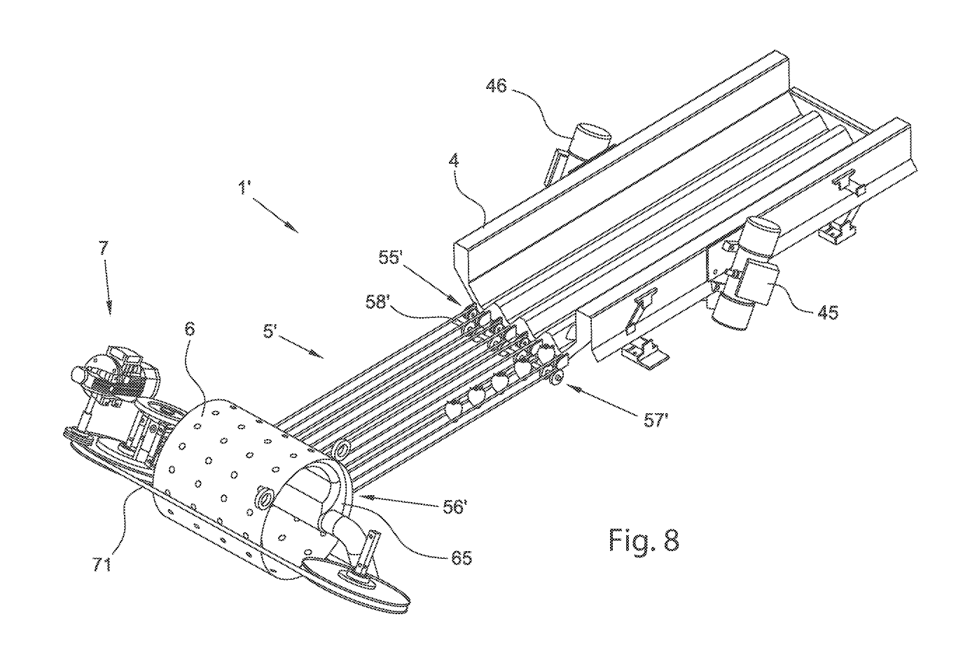

FIG. 8 shows a perspective, cut-away view of an automatic machine for cleaning and cutting fruit, particularly strawberries and radishes, according to a third embodiment of the present invention;

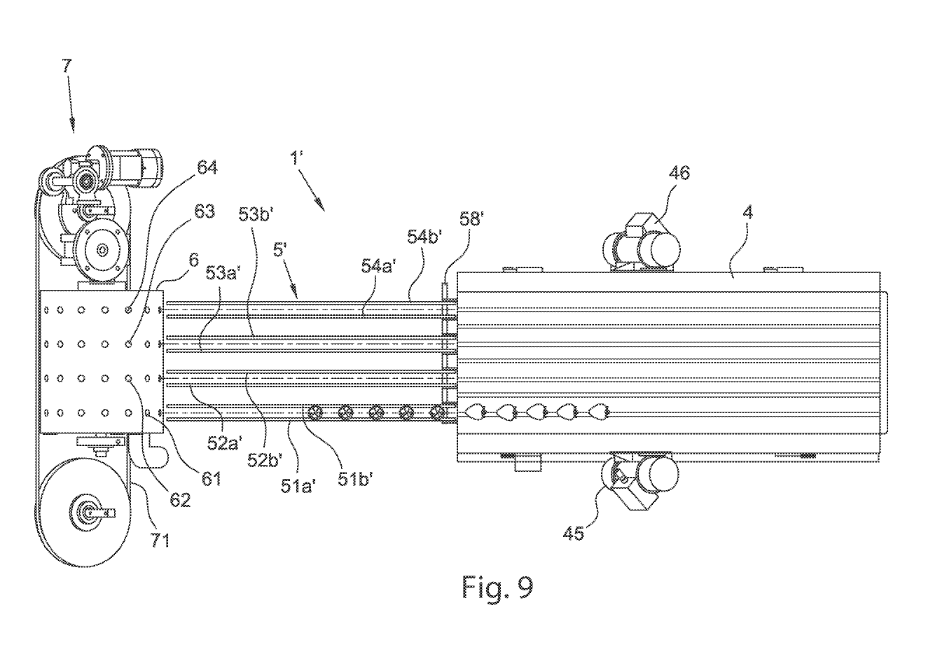

FIG. 9 shows a top plan view of the machine of FIG. 8;

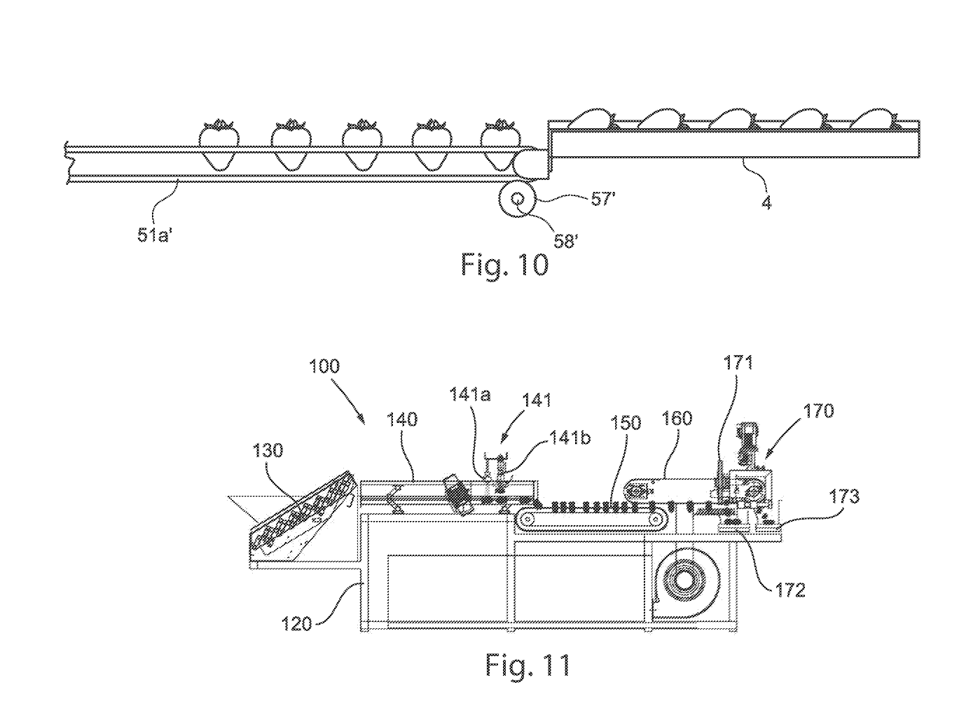

FIG. 10 is a section view taken along line D-D in FIG. 9;

FIG. 11 shows a longitudinal section view of an automatic machine for cleaning and cutting fruit, particularly strawberries and radishes, according to a fourth embodiment of the present invention;

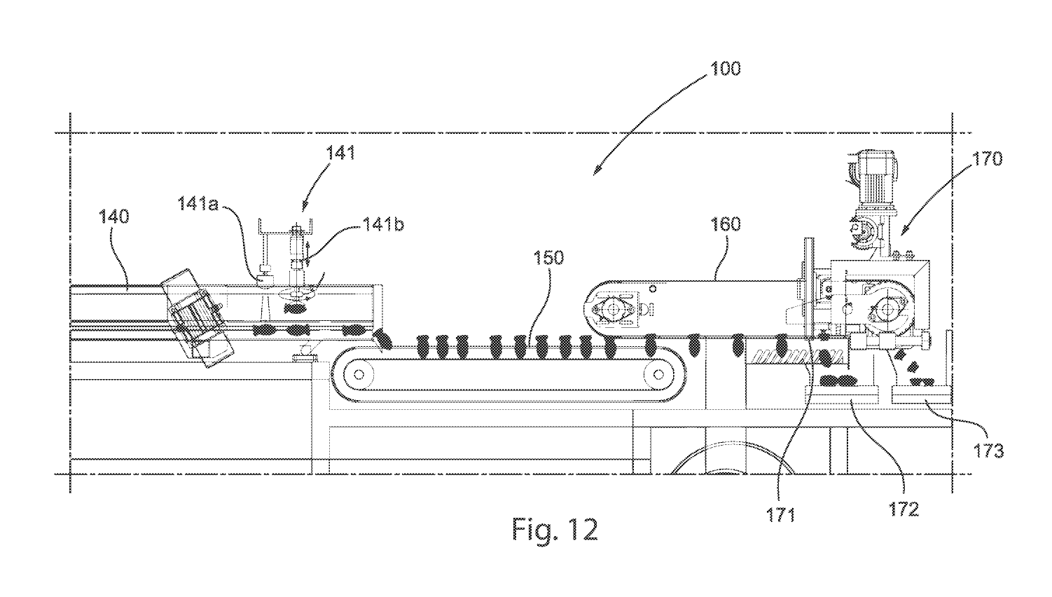

FIG. 12 is a detailed view of FIG. 11;

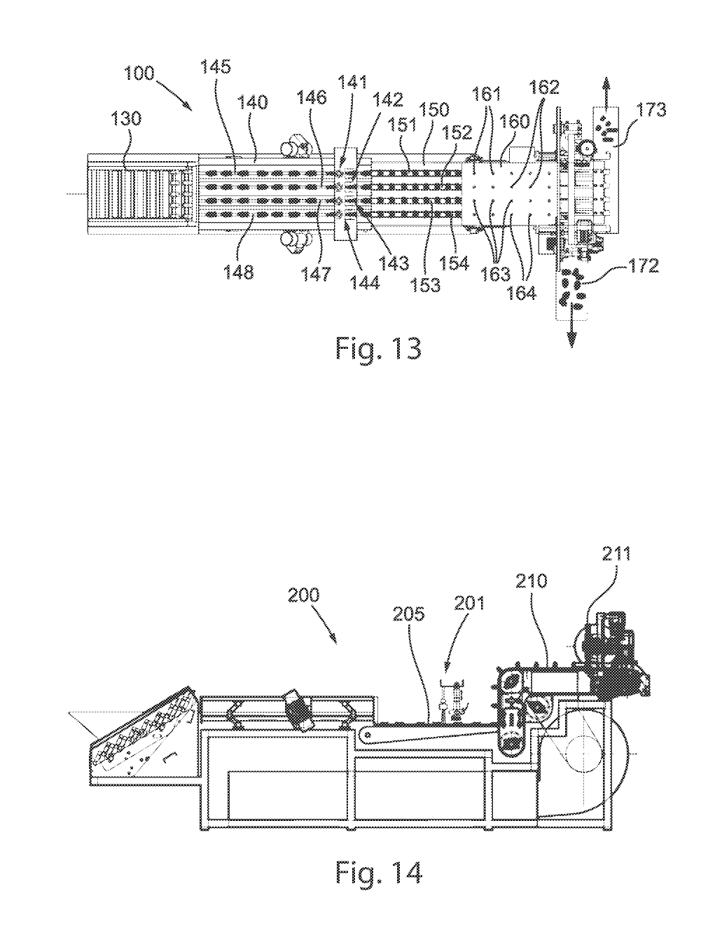

FIG. 13 shows a top plan view of the machine of FIG. 11;

FIG. 14 shows a longitudinal section view of an automatic machine for cleaning and cutting fruit, particularly strawberries and radishes, according to a fifth embodiment of the present invention;

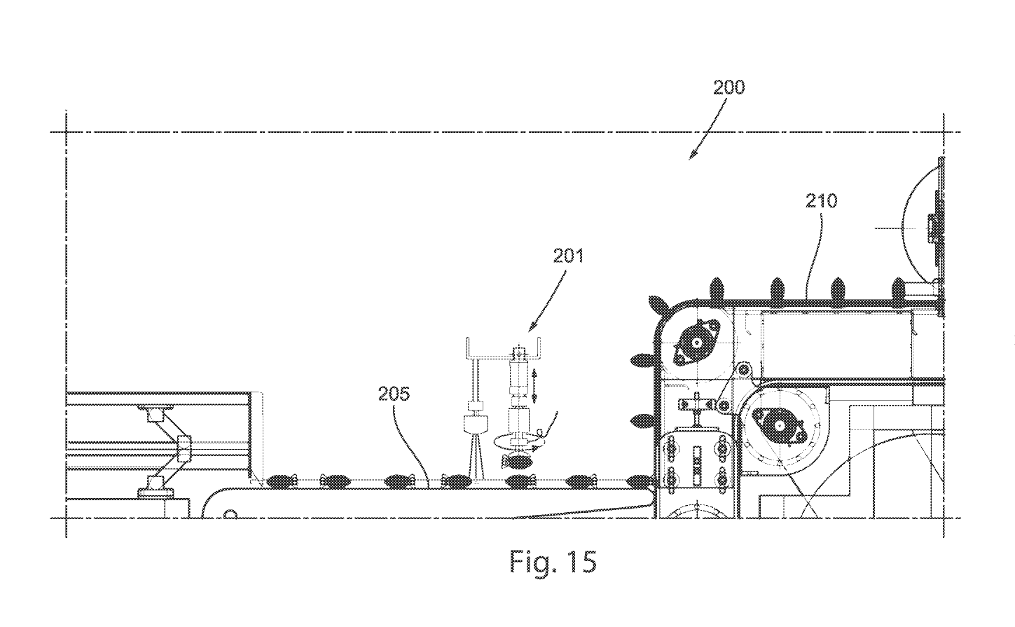

FIG. 15 is a detailed view of FIG. 14;

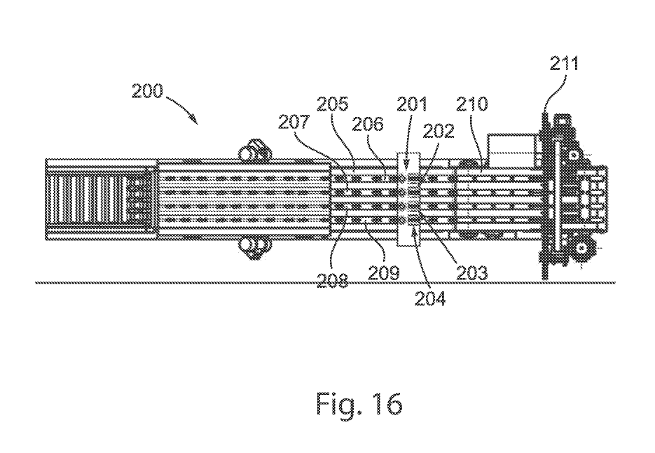

FIG. 16 shows a top plan view of the machine of FIG. 14; and

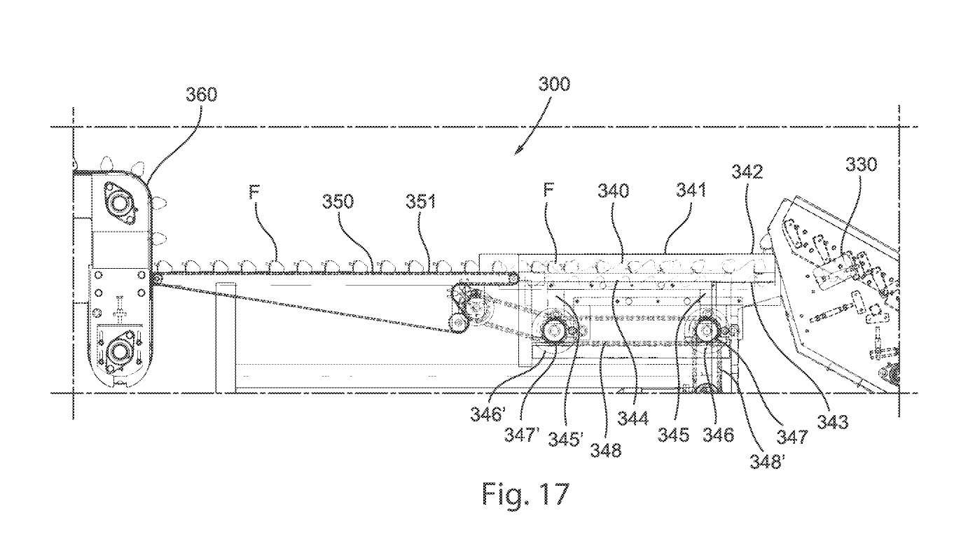

FIG. 17 shows a longitudinal section view of an automatic machine for cleaning and cutting fruit, particularly strawberries and radishes, according to a sixth embodiment of the present invention.

In the different views, similar parts will be indicated by the same reference numbers.

Making reference to FIGS. 1-4, by reference 401 it is indicated an automatic machine for cleaning and cutting strawberries.

Said machine 401 comprises a frame 402 for supporting a plurality of machining units.

The first unit is represented by a stepper hopper 403 comprising an alternating motion system.

Said stepper hopper 403 is adapted to receive the strawberries in a disorderly manner and convey them to fall into the next unit, by means of said alternating system which raises a single strawberry at a time from the hopper 403 and drops it into the next unit.

This stepper machine 403 moves at a predetermined speed.

The second unit, located downstream of stepper hopper 403, is represented by a vibrating table 404, provided with a plurality of channels 441, 442, 443, 444 and a pair of pneumatic actuators 445 and 446, suitable for handling said vibrating table 404.

Said vibrating table 404 is adapted to receive strawberries in a disorderly manner from the stepper hopper 403, to orient and pre-align them in an orderly way along the plurality of channels 441, 442, 443, 444 of which it is provided, as a result of vibration generated by the pair of pneumatic actuators 445 and 446.

Said plurality of channels preferably includes a first 441, a second 442, a third 443, and a fourth 444 channels, parallel each other, in which strawberries are positioned neatly as a result of the movement of the vibrating table 404, as will be described in detail in the following.

Said plurality of channels 441, 442, 443 and 444 can also be in number other than four, for example two, three, five or six.

Said vibrating table 404 is disposed inclined with respect to the support frame 402, so as to facilitate the fall of the strawberries into the next unit by gravity.

Advancement speed of the strawberries on the vibrating table 404 is double with respect to the speed with which stepper hopper 403 moves.

The third unit, located downstream the vibrating table 404, is represented by a conveyor belt 405 provided with a plurality of rails 451, 452, 453, 454, parallel each other and equal in number to the plurality of channels 441, 442, 443, 444 of said vibrating table 404.

Said conveyor belt 405 is suitable to receive strawberries from said vibrating table 404 that fall by gravity within the plurality of rails 451, 452, 453, 454, to align them in an orderly manner and with the head facing forward along an advancing direction X′ of strawberries in machine 401 and to transport them to the next unit, as will be described in detail in the following.

In correspondence of the conveyor belt 405 it is provided a space for access by an operator, who could intervene in the repositioning of strawberries if these are not perfectly channeled into the plurality of rails 451, 452, 453, 454 and will not be oriented with their head faced towards the direction of advance X′.

Sliding speed of the conveyor belt 405 is triple compared to that with which stepper hopper 403 moves.

The fourth unit, placed downstream the conveyor belt 405 and offset with respect to the same is represented by a perforated belt 406 within which a system is disposed for the generation of vacuum, not shown in the figure, so as to create a vacuum at the holes of the belt 406, to make strawberries heads adhering on said perforated belt 406.

Holes in the perforated belt 406 are aligned each other along parallel rows reflecting the arrangement of said plurality of rails 451, 452, 453, 454.

A cutting device 407 is placed downstream the perforated belt 406, by which strawberries are cut and deprived of the tuft.

A monofilament control belt 408 is provided downstream the cutting device 407, having a first end 408a positioned in correspondence of said perforated belt 406 and a second end 408b facing on a first container 409, adapted to collect the cut strawberries for consumption.

In correspondence of said monofilament control belt 408 it is provided an air generator, not shown in the figure, adapted to remove any residual leaves from the strawberries cut.

In a region adjacent to said first container 409, at the bottom of a section Z of said perforated belt 406 not subjected to vacuum, it is disposed a second container 410 suitable to the collection of the cut tufts.

Operation of the machine 401 described in the above occurs in the following way.

The hopper stepper 403 is filled with the strawberries from work randomly placed.

The alternating system raises the strawberries one at a time from the hopper and makes them falling on the vibrating table 404. By gravity, the heaviest part of the strawberry, namely that comprising the tuft, faces forwards, i.e. towards the advancement direction X′ of strawberries in the machine 401.

Pneumatic actuators 445 and 446 begin moving the vibrating table 404, thus strawberries tend to arrange themselves neatly within the plurality of channels 441, 442, 443, 444, with the head facing forward.

The strawberries so ordered and pre-aligned, fall then on the conveyor belt 405 by gravity, within the plurality of rails 451, 452, 453, 454, so as to be all aligned along the advancement direction X′.

If the strawberries would not result all aligned within the plurality of rails 451, 452, 453, and 454, with the head facing forward, an operator may manually correct alignment.

When the conveyor belt 405 leads strawberries towards the perforated belt 406, they are subjected to a force of attraction toward said perforated belt 406 due to the vacuum acting through the holes of said perforated belt 406.

Strawberries then adhere with the part containing the tuft to the perforated belt 406.

The perforated belt 406 brings strawberries towards the cutting device 407 that cuts the strawberries, preferably in half and deprives them of the tuft.

The pieces of cut strawberries reach the monofilament control belt 408 which conveys them, by means of said free end 408b, inside the first container 409.

In correspondence of said monofilament control belt 408, pieces of strawberries are invested by a puff of air coming from the air generator, said air removing residual of the tuft remained adherent to the pieces of cut strawberries.

These residues are then channelled into a suitable container, not shown in the figure.

The tuft, however, remains adhered to the perforated belt 406 until the same tuft does not reach zone Z of the perforated belt 406 that is not subjected to vacuum.

Upon reaching said area Z, the tuft, no longer subjected to the attraction force exerted by the vacuum, falls by gravity into the second container 410.

The transportation speed of strawberries within each processing unit progressively increases, unity by unity, in order to suitably space strawberries and to guarantee a better positioning within each processing unit.

Referring now to FIGS. 5-7, by reference number 1 it is shown a second automatic machine for cleaning and cutting strawberries.

Said machine 1 comprises a frame 2 for supporting a plurality of machining units.

The first unit is represented by a hopper 3, comprising a stepper alternating motion system.

Said stepper hopper 3 is adapted to receive strawberries F in a disorderly manner and convey them to fall into the next unit, by means of said alternating system which raises a single strawberry F at a time from the hopper 3 and lets it falling into the next unit.

This stepper machine 3 moves at a predetermined speed.

The second unit, located downstream of the stepper hopper 3, is represented by a vibrating table 4, provided with a plurality of channels 41, 42, 43, 44 and a pair of pneumatic actuators 45 and 46, suitable to move said vibrating table 4.

Said vibrating table 4 is suitable to receive the strawberries F, in a disorderly manner from the stepper hopper 3, to orient and pre-align them in an orderly way along the plurality of channels 41, 42, 43, 44, following the vibration generated by the pair of pneumatic actuators 45 and 46.

Said plurality of channels preferably comprises a first 41, a second 42, a third 43, and a fourth 44 channels, parallel each other, in which are neatly positioned strawberries F due to the movement of the vibrating table 4, as will be described in detail below.

Said plurality of channels 41, 42, 43 and 44, can also be present in a number other than four, for example two, three, five or six.

Said vibrating table 4 is disposed inclined with respect to the support frame 2, in order to facilitate the fall of strawberries F by gravity into the following unit.

The advancement speed of strawberries F on the vibrating table 4 is double with respect to the speed with which the stepper hopper 3 moves.

The third unit, located downstream the vibrating table 4, is represented by a conveyor belt 5 provided with a plurality of rails 51, 52, 53, 54, namely a first rail 51, a second rail 52, a third rail 53 and a fourth rail 54, parallel each other and respectively aligned to said plurality of channels 41, 42, 43, 44 of the vibrating table 4.

Said conveyor belt 5 is suitable to receive strawberries F from said vibrating table 4 falling by gravity within the plurality of rails 51, 52, 53, 54, to align them in an orderly manner along an advancement direction X of strawberries F in the machine 1 and to transport them to the next unit, as will be described in detail in the following.

Above to a predetermined zone of the conveyor belt 5 there are provided, placed side by side each other, a first orientation correction device 511, a second orientation correction device 512, a third orientation correction device 513 and a fourth orientation correction device 514, acting to correct the orientation of the strawberries F, and respectively arranged in correspondence of said plurality of rails 51, 52, 53, 54.

Each one of said first orientation correction device 511, second orientation correction device 512, third orientation correction device 513 and fourth orientation correction device 514 includes a respective optical sensor 514a, to detect—on the basis of shapes and colours present in the acquired image—the orientation of the strawberries F when the latter pass below this optical sensor 514a, and an inverter guide device 514b to reverse the orientation of the strawberries F passing under said inverter guide device 514b, by rotating them by 180°.

In particular, the aforementioned inverter guide device 514b is provided downstream the optical sensor 514a and is operatively connected to the latter.

Substantially, each orientation correction device 511, 512, 513, 514 operates so that when the respective optical sensor 514a detects that a particular strawberry F has its tip, i.e. the side opposite to the tuft, facing in the advancement direction X, operates after a certain period of time—corresponding to the time taken from strawberry to arrive under the orientation inverter device 514b—the orientation inverter device 514b taking the strawberry by means of a pneumatic suction cup and making it rotating by 180° so as to position it with the tuft facing towards the advancement direction X.

The sliding speed of the conveyor belt 5 is triple with respect to that with which the stepper hopper 3 moves.

Downstream the conveyor belt 5 it is, however, provided an axially hollow cylinder 6, on the outer lateral surface of which there are realised a first circumferential row of holes 61, a second circumferential row of holes 62, a third circumferential row of holes 63 and a fourth circumferential row of holes 64, arranged respectively aligned with respect to said first rail 51, second rail 52, third rail 53 and fourth rail 54.

Said cylinder 6 is connected to an engine suitable to make it rotating around its own axis, with a direction of rotation R concurrent with respect to the advancement direction X.

Within the cylinder 6 it is provided a fixed housing 65, creating an internal chamber communicating with an upper portion of said cylinder 6.

The housing 65 is connected to a vacuum pump 66 for creating a vacuum inside said inner chamber, in such a way that, when the strawberries F are arranged in holes of the rotating cylinder 6, they remain adhering to the same cylinder 6 by vacuum present in the inner chamber.

Machine 1 also comprises a cutting device 7—best shown in FIGS. 8 and 9—of the type described in the Italian patent application RM2013A000225 of the same Applicant.

Particularly, the cutting belt 71 of said cutting device 7 passes close to said cylinder 6 downstream the latter, so as to cut strawberries F carried by cylinder 6, removing the relative waste part, namely the part with the tuft, which falls by gravity into a collection container or conveyor belt 8 below, when no longer subjected to the action of the vacuum.

The “good” part of the strawberry, or that resulting by the removal of the part with the tuft, is instead collected on a second conveyor belt 9, accessible to an operator to enable him/her to carry out a final check on the strawberries F.

The operation of the above machine 1 occurs in the following way.

The stepper hopper 3 is filled with strawberries F to be treated positioned randomly.

The alternating system raises strawberries F one at a time from the hopper and makes them falling on the vibrating table 4. The pneumatic actuators 45 and 46 begin to move the vibrating table 4, allowing, therefore, strawberries F to be neatly arranged inside the plurality of channels 41, 42, 43, 44.

Strawberries F so ordered and pre-aligned fall then on the conveyor belt 5, by gravity, within the plurality of rails 51, 52, 53, 54, so as to be all aligned according to the advancement direction X.

By operation of the orientation correction devices 511, 512, 513, 514 described above, strawberries F reaching the bottom of the conveyor belt 5 are all arranged with the tuft facing in the advancement direction X, i.e. towards cylinder 6.

Thus, strawberries F are placed in holes 61, 62, 63, 64 of cylinder 6 with the respective tuft facing inside of said cylinder 6.

Strawberries F remain, therefore, attached to said cylinder 6, due to the attraction exerted by the vacuum present inside the casing 65, until they come in contact with the cutting belt 71 of the cutting device 7.

When strawberries F contact the cutting belt 71, the respective waste part with the tuft falls by gravity into the underlying collection conveyor belt 8, while the remaining part, the so-called “good” part, falls on the second conveyor belt 9, where it is optionally subjected to a final check by an operator.

Making now specific reference to FIGS. 8-10, by reference number 1′ it is indicated a third automatic machine for cleaning and cutting strawberries substantially equal to machine 1 described in the above, except for the provision of a particular transportation device 5′, different from the tape conveyor 5, between the vibrating table 4 and the cylinder 6, and for the absence of devices for the correction of the orientation of strawberries.

Above-mentioned transportation device 5′ comprises a first pair of ropes 51a′, 51b′, a second pair of ropes 52a′, 52b′, a third pair of ropes 53a′, 53b′, a fourth pair of ropes 54a′, 54b′, in which said ropes are parallel each other and directed according to the advancement direction X, so that said pairs of ropes are respectively aligned with said first channel 41, second channel 42, third channel 43 and fourth channel 44.

Ropes of said pairs of ropes 51a′, 51b′, 52a′, 52b′, 53a′, 53b′, 54a′, 54b′ are also wound on a first plurality of pulleys 55 ‘connected to the vibrating table 4 and on a second plurality of pulleys 56’ arranged adjacent to the cylinder 6.

In correspondence of the first plurality of pulleys 55′ it is provided a corresponding plurality of drive rollers 57′, keyed on a motor shaft 58′ connected to suitable motor means suitable to rotate it around its own axis.

Each roller of the plurality of drive rollers 57′ is in contact with the lower branch of a respective rope of said pairs of ropes 51a′ and 51b′, 52a′ and 52b′, 53a′ and 53b′, 54a′ and 54b′, so as to allow its movement according to the advancement direction X when it is operated rotation of the motor shaft 58′, and thus also of the drive rollers 57′.

Machine 1′ then operates in such a way that, when the strawberries fall by gravity from the vibrating table 4, they must be arranged in the interspaces present between each pair of ropes 51a′ and 51b′, 52a′ and 52b′, 53a′ and 53b′, 54a′ and 54b′, supported by the same ropes and with the waste part with the tuft facing upwards.

Strawberries, thus ordered, are then transported by the transportation device 5′ up to the cylinder 6, where they are picked, thanks to the action of attraction of the vacuum generated in the housing 65, being placed within holes 61, 62, 63, 64 with the respective tuft facing inside the cylinder 6 itself.

Therefore, in this way, when strawberries contact the cutting belt 71 of the cutting device 7 by the rotation of the cylinder 6, they are cut in such a way that the “good” part of them falls in a collection area, constituted for example by a conveyor or container, and in such a way that parts with the tuft fall, instead, in a separate conveyor belt or collection container, once such parties have reached an area not affected by the vacuum.

Making instead reference to FIGS. 11-13, by reference number 100 it is indicated a fourth automatic machine for cleaning and cutting strawberries, comprising a frame 120 for supporting a stepper hopper 130 and a vibrating table 140 disposed downstream of the stepper hopper 130, and comprising a fifth channel 145, a sixth channel 146, a seventh channel 147 and an eighth channel 148, arranged parallel each other.

In this regard, it is noted that the stepper hopper 130 and the vibrating table 140 are equal to those described with reference to machine 1.

Above to a given area of the vibrating table 140 there are provided a fifth orientation correction device 141, a sixth orientation correction device 142, a seventh orientation correction device 143 and an eighth device orientation correction 144, equal to the orientation correction devices 511, 512, 513, 514 of the machine 1 described in the above and arranged, respectively, in correspondence of channels 145, 146, 147, 148.

Downstream the vibrating table 140 and at a lower height with respect to the same, there is provided a conveyor belt 150 with the alignment function of the strawberries.

Particularly, in the conveyor belt 150 there are realised a first groove 151, a second groove 152, a third groove 153 and a fourth groove 154, having substantially trapezoidal cross section, tapering downward, and arranged respectively aligned with channels 145, 146, 147, 148 of the vibrating table 140.

Downstream said conveyor belt 150 it is, however, provided a further conveyor belt 160 arranged at a higher level with respect to said conveyor belt 150 and provided with a first longitudinal row of holes 161, a second row of longitudinal holes 162, a third row of longitudinal holes 163 and a fourth row of longitudinal holes 164, respectively aligned with said grooves 151, 152, 153, 154 of the conveyor belt 150.

Inside the conveyor belt 160 it is provided a system for the generation of vacuum operable to generate vacuum on the lower branch of said conveyor belt 160.

Machine 100 also comprises a cutting device 170 of the type described in Italian patent application RM2013A000225 of the same Applicant.

The cutting device 170 comprises a cutting belt 171 passing through an area adjacent to the lower branch of the said conveyor belt 160 and affected by the vacuum generated by said system for the generation of the vacuum.

Below the cutting belt 171 it is provided a first collection conveyor belt 172 for the collection of “good” parts of the strawberries.

Under a transition area of said conveyor belt 160 between the empty condition and “normal” environmental conditions, it is instead provided a second conveyor belt 173 to allow collection of waste parts of the strawberries, or of those with the tuft .

Operation of the machine 100 provides that strawberries are transported from the hopper 130 to the stepper vibration table 140 where, thanks to the operation of above orientation correction devices 141, 142, 143, 144, takes all the orientation with the tuft facing backward, i.e. toward the stepper hopper 130.

Therefore, in this way, strawberries outgoing from the vibrating table 140 fall by gravity inside the grooves 151, 152, 153, 154 of the conveyor belt 150 with the tuft facing upward (see FIG. 12).

Therefore conveyor belt 150 carries strawberries, so arranged, to the next conveyor belt 160, in such a way that, as soon as the strawberries reach the area of the latter in which it operates the vacuum, they are removed from above, being placed in holes 161, 162, 163, 164 with the respective tuft facing towards the inside of the conveyor belt 160.

Strawberries so suspended are driven by the moving conveyor belt 160 toward the cutting belt 171 of the cutting device 170.

After that strawberries are cut by the cutting belt 171, the “good” parts of them fall immediately downward, where they are collected by the first collection conveyor belt 172, while parts with the tuft remain attached to the conveyor belt 160 until the limit of the area subjected to vacuum, in correspondence of which they fall into the second collection conveyor belt 173.

Referring now to FIGS. 14 to 16, by reference number 200 it is indicated a further automatic machine for cleaning and cutting strawberries, substantially equal to the first machine 401, with the addition of a plurality of orientation correction devices 201, 202, 203, 204, of the type described in the above, arranged, respectively, above the rails 206, 207, 208, 209 of the conveyor belt 205.

Such orientation correction devices 201, 202, 203, 204 perform, even in this case, the function of orienting the strawberries transported by the conveyor belt 205 so that the respective tuft is facing the perforated belt 210, subject to the vacuum and bringing to the cutting device 211.

FIG. 17 illustrates a further automatic machine for cleaning and cutting strawberries, indicated by reference number 300.

Machine 300 comprises a stepper hopper 330 for lifting and feeding strawberries F, downstream of which it is provided a further stepper motion system 340 comprised of a series of channels 341, parallel each other and each one having a substantially trapezoidal cross-section with the tapered part facing downwards, so as to form an upper longitudinal opening 342 and a lower longitudinal opening 343, having a lesser width than the upper longitudinal opening 342.

To facilitate passage of the strawberries F within the channels 341, the inner walls of the latter are coated with an anti-friction material.

The stepper motion system 340 further provides, for each channel of said series of channels 341, a movable member 344 substantially resembling a comb, with the teeth facing upwards.

Such a movable member 344 is disposed below the respective channel 341, corresponding to the relative lower opening 343, and is also provided with two lower supports 345, 345′, connected eccentrically to two respective wheels 346, 346′, having parallel axes, and bearing, axially, respective gears 347, 347′, on which it is wound a chain 348 adapted to mutually connect said wheels 346, 346′ and to allow their simultaneous rotation about their respective axes.

The wheel 346 axially carries a further gear connected, by means of a second chain 348′, to a motor adapted to cause rotation of said wheel 346 about its axis.

When said engine is in operation, each movable member 344 of the moving stepper system 340 moves with an undulatory motion, during which the teeth of said movable member 344 repeatedly cross the longitudinal opening 343 of the respective lower channel 341, contacting and batch advancing strawberries provided in said channel 341.

Downstream of the stepper motion system 340 described in the above, there is provided a transportation system 350 comprised of a series of pairs of chains 351 arranged at a distance each other so as to allow the housing of the strawberries F between the same chains, wherein each of said pairs of chains 351 is aligned with a respective channel 341 of the stepper motion system 340.

The above-mentioned series of pairs of chains 351 is connected to a motion system adapted to move said chains, and therefore also the strawberries F arranged on the same, continuously or step-by-step (i.e. according subsequent advancements) in a synchronized manner with respect to the undulatory movement of the movable member 344 of the stepper motion system 340.

According to a variation of the machine 300, the chains described above are replaced by ropes.

Downstream the transportation system 350, it is placed a perforated belt 360—identical to the above mentioned perforated belt 210—subject to the vacuum and driving to a cutting device identical to the above mentioned cutting device 211.

Operation of the machine 300 provides that strawberries F, once fallen by gravity from the top of the stepper hopper 330 within the channels 341, are transported according subsequent advancements to the transition zone by the transportation system 350, thanks to the undulatory movement of the movable member 344.

Particularly, the undulatory movement of each movable member 344 makes strawberries F within the channels 341 being oriented with their heads, with the green part, facing downstream, i.e. towards the transportation system 350 and arriving at said transition zone separated by a predetermined distance.

Once passed the entire length of the channels 341, strawberries F are taken over by the said series of pairs of chains 351, which will bring them up to the perforated belt 360, where they will be withdrawn by the vacuum effect.

During the path strawberries FA run by the transportation system 350, strawberries eventually not properly oriented, i.e. with their head not directed downstream, can be positioned correctly thanks to the manual intervention of an operator or to that of orientation correction devices of the type described above.

The perforated belt 360 will, finally, carry strawberries F with its head inserted into each hole of the perforated belt 360, until the cutting device for removal of the green part of the strawberries.

The present invention has been described for illustrative but not limitative purposes, according to its preferred embodiments, but it is to be understood that variations and/or modifications may be introduced by those skilled in the art without departing from the relative scope, as defined by the appended claims.

1. Automatic machine for cutting fruit, particularly strawberries or radishes, comprising:
an aligning and transporting unit (4, 140, 340, and 404) for aligning, according to at least one line, and transporting fruits (F) from an origin zone to a first destination zone;
a placing and transporting unit (5, 5′, 150, 205, 350, 405) for placing said fruits (F) according to a predetermined orientation and transporting said fruits (F) from said first destination zone to a second destination zone, said placing and transporting unit (5, 5′, 150, 205, 350, 405) being arranged downstream said aligning and transporting unit (4, 140, 340, 404);
a conveying unit (6, 160, 210, 406) for conveying said fruits (F) from said second destination zone to a third destination zone, said conveying unit (6, 160, 210, 406) comprising a vacuum-generating device (66) to make a respective waste portion of said fruits (F) adhering to said conveying unit (6, 160, 210) by vacuum, said conveying unit (6, 160, 210, 406) being arranged downstream said placing and transporting unit (5, 5′, 150, 205, 350, 405); and
a cutting unit (7, 170, 211, 407) for cutting said fruits (F) in correspondence of said third destination zone such as to remove said respective waste portion of said fruits (F).

2. The automatic machine according to claim 1, comprising a feeding unit (3, 130, 403) for supplying fruits (F) to said aligning and transporting unit (4, 140, 404); said feeding unit (3, 130, 403) being arranged upstream said aligning and transporting unit (4, 140, 404).

3. The automatic machine according to claim 1, comprising detection and orientation correction means (511, 512, 513, 514; 141, 142, 143, 144; 201, 202, 203, 204) to detect orientation of fruits (F) and, when detected orientation is different from a predetermined orientation, to orient said fruits (F) according to said predetermined orientation before said fruits (F) arrive at said conveying unit (6, 160, 210).

4. The automatic machine according to claim 1, wherein said conveying unit comprises a hollow cylinder (6) having a lateral surface provided with a plurality of through holes configured to receive a portion of said fruits (F) and in communication with said vacuum-generating device (66); said hollow cylinder (6) being rotatable about its axis.

5. The automatic machine according to claim 4, wherein said conveying unit comprises a case (65) arranged inside said hollow cylinder (6) so as to realize a chamber along with a portion of said hollow cylinder (6); said chamber being in communication with said vacuum-generating device (66) and with through holes provided in said portion of said hollow cylinder (6).

6. The automatic machine according to claim 4, wherein said through holes of said plurality of through holes are arranged according to at least one circumferential line.

7. The automatic machine according to claim 1, wherein said placing and transporting unit comprises at least a pair of ropes (51a′, 51b′, 52a′, 52b′, 53a′, 53b′, 54a′, 54b′) substantially parallel each other and arranged at such a distance each other to allow placing a fruit in a space comprised between said ropes, wherein each rope of said at least a pair of ropes (51a′, 51b′, 52a′, 52b′, 53a′, 53b′, 54a′, 54b′) is wound on a first pulley (55′) and on a second pulley (56′); said placing and transporting unit further comprising moving means to make said at least one pair of ropes (51a′, 51b′, 52a′, 52b′, 53a′, 53b′, 54a′, 54b′) run on said first pulley (55′) and said second pulley (56′).

8. The automatic machine according to claim 1, wherein said placing and transporting unit comprises a first conveyor belt (150), wherein at least one groove (151, 152, 153, 154) is formed, said at least one groove being configured so as to receive said fruits (F) positioned with respective waste portion facing upwards, namely towards a direction opposite to said first conveyor belt (150).

9. The automatic machine according to claim 8, wherein said conveying unit comprises a second conveyor belt (160) provided with a plurality of holes which are in communication with said vacuum-generating device (66); said second conveyor belt (160) being at least partially arranged above said first conveyor belt (150), so that fruits (F) transported by said first conveyor belt (150) are attracted from above towards said holes of said second conveyor belt (160) by vacuum generated by said vacuum-generating device (66).

10. The automatic machine according to claim 9, wherein said third destination zone, where said fruits (F) are cut, is provided below said second conveyor belt (160).

11. The automatic machine according to claim 1, comprising a third conveyor belt (173) for collecting respective waste portion of said fruits (F), and a fourth conveyor belt (172) for collecting remaining portion of said fruits (F), said fourth conveyor belt (172) being arranged below said third destination zone.

12. The automatic machine according to claim 1, wherein said aligning and transporting unit (340) comprises at least one channel (341) having a lower portion which is tapered downward and open, and at least one movable member (344) which is substantially comb-shaped and connected with a moving system adapted to make said movable member (344) move in a substantially undulating way, such that, when in use, fruits (F) arrive at the end of said at least one channel (341), which fruits (F) being spaced apart by a predetermined reciprocal distance.
